(19) United States
(12) Patent Application Publication
(10) Pub. No.: US 2010/0145799 A1
(43) Pub. Date: Jun. 10, 2010

(54) Method of Determining Optimum Locations for Rooftop Advertising

(76) Inventor: Cyril Caesar, Miami, FL (US)

Correspondence Address: ROBERT M. SCHWARTZ, P.A., P.O. BOX 221470, HOLLYWOOD, FL, 33022, US

(21) Appl. No.: 12/634,280

(22) Filed: Dec. 9, 2009

Related U.S. Application Data
(60) Provisional application No. 61/120,907, filed on Dec. 9, 2008.

(51) Int. Cl. G06Q 30/00

(52) U.S. Cl. 705/14.49

(57) ABSTRACT

The present invention is a method of optimizing rooftop advertising by identifying flight approach paths at a given airport, graphing offset radial lines from 0°-30° on both sides of a runway center line from a point at the end of a runway, to a point between 3 to 5 miles from the runway, and locating buildings with rooftop surface area within the radial lines and then displaying advertising on said selected rooftop surfaces.

### INDEX TO RELATED APPLICATIONS

This application claims the benefit of U.S. Provisional Patent No. 61/120,907 filed Dec. 9, 2008, the disclosure of which is incorporated herein by reference in its entirety.

### BACKGROUND OF THE INVENTION

The use of billboards to advertise products and services is well known. Typically, these billboards are observed along highways where high volumes of cars with passengers pass by on a daily basis. Rooftop advertising can be an effective way to reach potential consumers. In a similar method as billboards along highways done previously, there has not been a method to direct such rooftop advertising to a high concentration of observers.

The present invention addresses the need for effective rooftop advertising at airports, where airplane traffic rivals car traffic.

### BRIEF SUMMARY OF THE INVENTION

Major airports transport tens of thousands of passengers every single day. There are many buildings near airports that could provide effective locations for rooftop advertising. The crucial question remains as to how to identify suitable buildings and arrange the use of the qualified buildings' rooftops.

Advertisers will choose airports based on passenger volume. Both departure and arriving passenger counts are analyzed. Active runways are then identified and charted using Google Earth® or other similar programs. Emphasis is placed on runway activity at that airport.

Google Earth® is employed to map out runways and potential advertising sites. A flight path grid is overlaid onto a Google® Satellite image. A general assumption is for the flight path grid to be between 6 to 10 degrees from center line of an active runway for arriving flights and 25 to 30 degrees from center line of an active runway for departing flights. The gridline will be extended 5 miles on either side of the runways center line. This grid will produce optimum passenger views during descent and departure, and will capture an aircrafts flight pattern at its slowest and least maneuverable.

Sites are located along the flight path grid. Ideal sites should have limited HVAC equipment on the roof. A preferred minimum square footage of a rooftop is 150 feet×100 feet, with advertising art size increased to accommodate aircraft altitude and site visibility.

These ideal sites are inventoried in Google Earth® as place marks. GPS coordinates and dimensions are logged which are then used for model development in MICROSOFT® FSX.

The recorded dimensions from Google Earth® are used to create MICROSOFT® FSX models. FS Design studio by Abacus® is used to create a model of the building to scale which is then imported into MICROSOFT® FSX using the GPS coordinates recorded in Google Earth®. Placement verification is also accomplished using FS Earth for fsx by wideview which interfaces coordinates between MICROSOFT® FSX and Google Earth®.

The Abacus Scenery Shortcut application is used in conjunction with MICROSOFT® FSX SDK to import models of the buildings into MICROSOFT® FSX at exactly the precise coordinates logged in Google Earth®. Placement verification is also accomplished using FS Earth for fsx by wideview which interfaces coordinates between MICROSOFT® FSX and Google Earth®.

Various flight simulator aircraft have been modified to allow viewing these models, which allows for placement viewing confirmation from a virtual aircraft cabin window seat.

In one embodiment, the present invention is a method of optimizing rooftop advertising comprising the steps of:

a. identifying flight approach paths at a given airport;

b. graphing offset radial lines from 0°-30° on both sides of a runway center line from a point at the end of a runway, to a point between 3 to 5 miles from the runway;

c. locating buildings with rooftop surface area within the radial lines;

d. confirming rooftop visibility attributes via virtual aircraft cabin observations when virtual aircraft is locked to runways glide slope utilizing a virtual environment with true runway and site coordinates.

The airplane flight approach paths are distinct for each available runway at a particular airport. Therefore, the angles and distances of the radial lines may be adjusted for individual airports.

Preferably, the buildings with available rooftops have an unobstructed surface of at least about 150 feet×100 feet.

Also, the buildings with available rooftops should have angular configurations suitable for aerial advertising in the flight approach paths. The rooftops may be angled or flat as determined by individual evaluation.

The present invention also is a method of rooftop advertising comprising the steps of:

a. identifying flight approach paths at a given airport;

b. graphing offset radial lines from 0°-30° on both sides of a runway center line from a point at the end of a runway, to a point between 3 to 5 miles from the runway at ¼ mile intervals;

c. locating buildings with available rooftop surface area within the radial lines at ¼ mile intervals;

d. disposing advertising indicia on the available rooftops.

The advertising indicia may be words, pictures, logos, or combinations thereof.

The invention further comprises a computerized system for identifying buildings for rooftop advertising comprising:

a. identifying flight approach paths at a given airport;

b. graphing offset radial lines from 0°-30° on both sides of a runway center line from a point between 3 to 5 miles from the runway;

c. Locating buildings with available rooftop surface area within the radial lines;

d. confirming rooftop visibility attributes via virtual aircraft cabin observations when virtual aircraft is locked to runways glide slope utilizing a virtual environment with true runway and site coordinates.

The system preferably has an algorithm to determine optimum roof orientation and viewing angle of located buildings based on the flight approach paths.

Additionally, the system may use commercially available satellite imagery such as Google Earth® and the like for identifying potential roof tops.

The system may have virtual or actual indicia disposed on said buildings.

### BRIEF DESCRIPTION OF THE DRAWINGS

FIG. 1 is an aerial view demonstrating the offset radial lines of the invention on one side of an airport runway.

FIG. 2 is a coordinate grid with offset lines on each side of an airplane flight approach line.

FIG. 3 is a view of rooftop advertising indicia as viewed through an aircraft window.

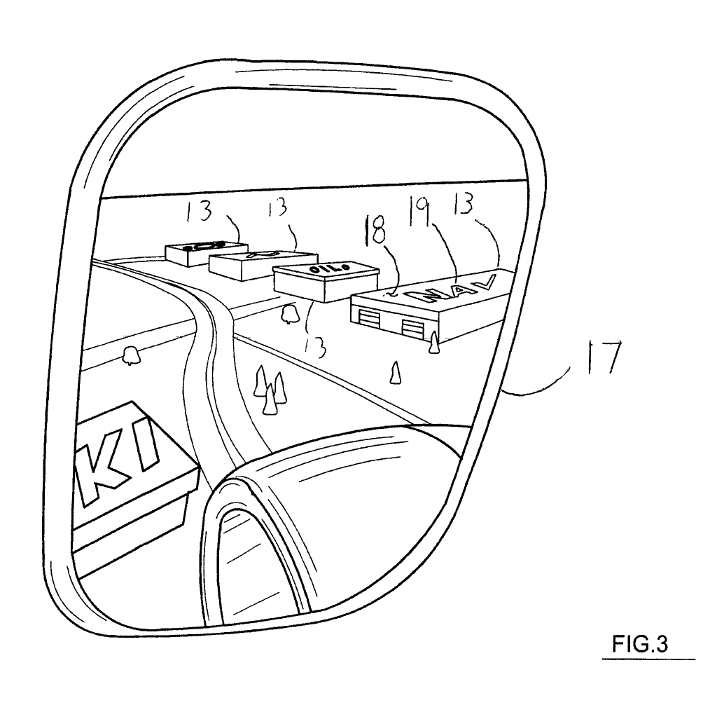

### DETAILED DESCRIPTION OF THE PREFERRED EMBODIMENTS

Airport runway 10 has endpoint 11. The system of the present invention creates radial lines 12 that begin from endpoint 11 and extend outward from endpoint 11 a distance of 3 to 5 miles. The radial lines 12 extend on both sides of runway center line 14. Center line 14 is a continuation of a straight line from the center of runway 10. Center line 14 extends outward from runway 10 approximately 3-5 miles. Each radial line 12 is separated by 6-10 degrees, such that each radial line 14 forms successive 6-10 degree angles starting from center line 14 starting and end point 11. The second radial line is 6-10 degrees more or 12-20 degrees from the center line. Likewise the third radial line is 16-30 degrees from the center line.

Building 13 with a roof top 18 of suitable size and configuration is identified. A suitable or preferred rooftop 18 will have an area of preferably at least 150 feet×100 feet and preferably a minimum area of at least 15,000 square feet. Further, a preferred rooftop 18 will be oriented such that indicia 19 disposed thereon are visible in aircraft traveling along the flight path as discussed herein. The indicia 19 are visible through conventional aircraft window 17.

The owner of building 13 is contacted and contracted with an advertising company to rent or lease the available rooftop 18 for disposition of advertising indicia 19. The advertiser need not own the building, but only needs an agreement with the building owner to dispose advertising indicia 19 thereon. The advertiser contacts owners or persons in control of buildings with preferred rooftops 18 to obtain advertising rights and subsequently practice the invention as disclosed herein.

In one embodiment, the system and method of the present invention uses computer animation to determine the suitability of a particular roof top. The animation may use known and common flight path and airplane descent information to determine the view ability of a roof top having advertising thereon. Common flight path is based on current practice and procedure. Aircraft taking off often deviate from center line 14 within the first mile from runway 10. Aircraft landing utilize an instrument landing system (ILS) to align the aircraft with the runway. Typically the instrument landing system (ILS) extends outward approximately 4.7 miles from the end of the runway. Thus, in a majority of aircraft landings, aircraft follow line 14 starting approximately 5 miles from the end point 11 of runway 10.

The advertising indicia 19 used in the present invention includes, but would not be limited to, printed or painted words, printed or painted logos, illuminated displays, video, plasma video, light emitting diodes (LED), liquid crystal displays (LCD), combinations thereof and the like. The indicia 19 are presented in configurations that will allow them to be viewed from window 17 by persons in aircraft flying over said indicia 19. The configurations would include appropriate size, shape, and if illuminated, light intensity and light contrast.

In one embodiment, printed displays are illuminated in the night and early morning so they may be viewed. Illuminated displays have adjustable contrast for optimizing view ability in various levels of sunlight intensity throughout the day. In one embodiment, the system and method includes audio and or visual notification of persons in an aircraft alerting said passengers to the displays or indicia 19 and where they may be viewed in relation to a particular aircraft.

In another embodiment advertising themes will include grouping one or more rooftops 18 for advertising using a combination of one or more rooftops 18 to deliver a desired message, theme or picture.

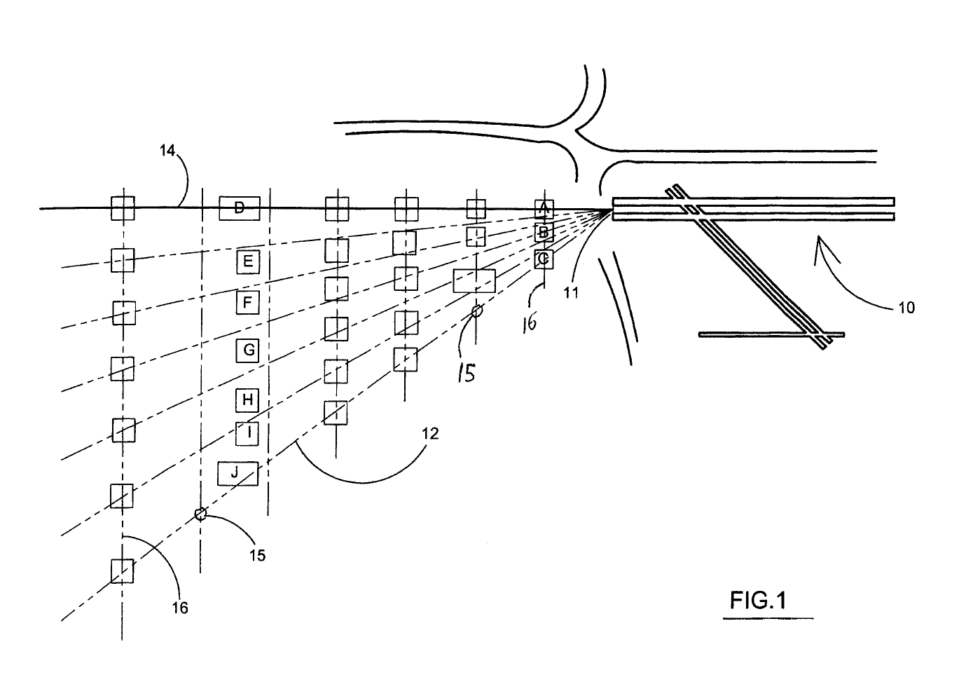

In a preferred embodiment advertising themes will include grouping two or more rooftops 18 for advertising using a combination of two or more rooftops 18 to deliver a desired message, theme or picture. The selected group of rooftops 18 would be on the same side of the runway line 14 so that passengers on one side of the plane would see the entire group of rooftop advertisements from the vantage point of their seat and looking through the airplane window 17 allotted to their seating. Although FIG. 1 shows lines and selected buildings 13 on one side of line 14, FIG. 1 is for illustrative purposes only. Preferably there would be two identical groups of advertising one on each side of the runway line 14 so that the passengers on each side of the plane would see substantially the same advertisement when landing or taking off.

Thus the grouping of multiple rooftops 18 of the present invention is useful for presenting a single advertisement utilizing multiple rooftops.

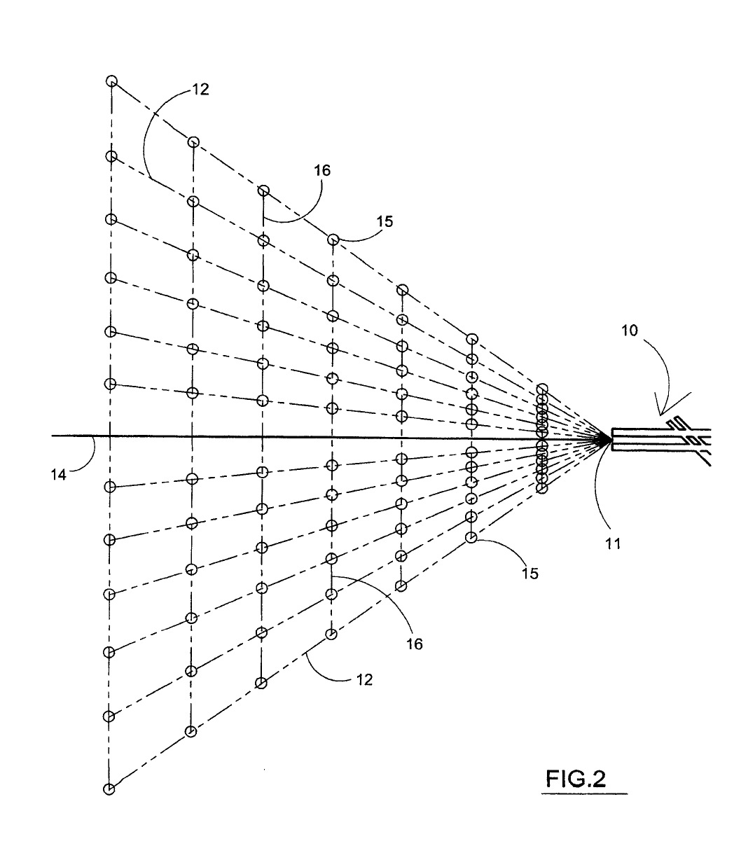

As depicted in FIG. 2 (not drawn to scale) the method includes graphing angular or radial lines from the end point 11 of runway 10 wherein the radial lines 12 are substantially equiangular. In a preferred embodiment, the radial lines 12 are 6-10°, 12-20°, and 18-30° angular offsets from the flight path line corresponding to line 14 and approaching the end of a runway 10 on both sides. The radial lines may be up to 15° apart. In a preferred embodiment, the radial lines are 5°-15° apart.

Then, horizontal lines 16 spaced ¼ mile apart and are graphed from the point at the end of the runway 11 outward a distance of approximately 5 miles, the lines are perpendicular to the flight path 14. The horizontal lines 16 can be ⅛-½ mile apart. The radial lines 14 can extend outward, preferably in the range of 1-7 miles from the end of point 11 on runway 10 for identifying buildings with best viewing from an aircraft.

At each intersection of the radial lines 12 and the horizontal lines 16 are intersection points 15 (although each point in FIGS. 1 and 2 are not labeled as such, each graphical intersection point depicted in FIGS. 1 and 2 are an intersection point 15 as understood herein). Thus, when graphing radial lines 12 and horizontal lines 16, a plurality of intersection points 15 or coordinates are formed. A preferred rooftop is chosen from available nearby rooftops. Selected preferred rooftops 18 are on or in proximity to intersection points 15. The preferred rooftops 18 are selected for disposition of rooftop advertising indicia 19.

Referring FIG. 1, rooftops A-B-C are selected as the closest available rooftops along horizontal grid line 16. Any or all of rooftops D, E, F, G, and H are along a horizontal grid line 16 and are the closest available and appropriate rooftops identified.

The positioning of rooftop advertising indicia 19 at regular intervals has the advantage of producing a series of indicia 19 that enlarges the overall advertisement to an area greater than the surface of a single rooftop 18. Thus, in one embodiment, multiple rooftop indicia 19 may comprise a single advertisement, icon, image, message, combinations thereof, and the like.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method of optimizing rooftop advertising comprising the steps of:
a. identifying flight approach paths at a given airport;
b. graphing offset radial lines from 0°-30° on both sides of a runway center line from a point at the end of a runway, to a point between 3 to 5 miles from the runway;
c. locating buildings with rooftop surface area within the radial lines;
d. confirming rooftop visibility attributes via virtual aircraft cabin observations when virtual aircraft is locked to runways glide slope utilizing a virtual environment with true runway and site coordinates.

2. The method of claim 1 wherein the flight approach paths are distinct for each available runway.

3. The method of claim 1 wherein the buildings with available rooftops have an unobstructed surface of at least about 150 feet×100 feet.

4. The method of claim 1 wherein the buildings with available rooftops have configurations suitable for aerial advertising in the flight approach paths.

5. The method of claim 1 comprising graphing horizontal lines substantially perpendicular to a flight approach line to a runway and identifying points of intersection between said radial lines and said horizontal lines.

6. The method of claim 5 wherein one or more rooftops are selected based on proximity to said intersecting points.

7. The method of claim 5 wherein two or more rooftops are selected based on proximity to said intersecting points.

8. The method of claim 1 wherein two or more rooftops contain indicia for a single advertisement.

9. A method of rooftop advertising comprising the steps of:
a. identifying flight approach paths at a given airport;
b. graphing offset radial lines from 0°-30° on both sides of a runway center line from a point between 3 to 5 miles from the runway;
c. graphing horizontal lines substantially perpendicular to the flight path line approaching an airport runway;
d. identifying intersecting points between said radian lines and said horizontal lines;
e. locating buildings with available rooftop surface area within the radial lines and relative to said intersecting points;
f. disposing advertising indicia on the available rooftops.

10. The method of claim 9 wherein the advertising indicia may comprise words, pictures, logos, or combinations thereof.

11. A system stored on a computer readable medium for identifying buildings for rooftop advertising comprising:
a. identifying flight approach paths at a given airport;
b. graphing offset radial lines from 0°-30° on both sides of a runway center line from a point between 3 to 5 miles from the runway;
c. Locating buildings with available rooftop surface area within the radial lines;
d. confirming rooftop visibility attributes via virtual aircraft cabin observations when virtual aircraft is locked to runways glide slope utilizing a virtual environment with true runway and site coordinates.

12. The system of claim 11 having an algorithm to determine optimum roof orientation and viewing angle of located buildings based on the flight approach paths.

13. The system of claim 11 having virtual or actual indicia disposed on said buildings.

14. The system of claim 11 comprising viewing said indicia.

15. The system of claim 11 wherein the viewing is virtual, actual, or combinations thereof.

16. The method of claim 1 wherein persons in airplanes approaching buildings with rooftop indicia are informed of the presence of said indicia.

17. The system of claim 11 wherein persons in airplanes approaching buildings with rooftop indicia are informed of the presence of said indicia.

18. The system of claim 11 wherein the advertising indicia may comprise words, pictures, logos, or combinations thereof.
